(19) United States
(12) Patent Application Publication
(10) Pub. No.: US 2015/0179080 A1
(43) Pub. Date: Jun. 25, 2015

(54) SYSTEMS AND METHODS FOR A PHYSICALLY INTUITIVE RESOURCE-CONSTRAINED ROUTE PLANNING TASK FOR ENHANCED COGNITION

(71) Applicant: LUMOS LABS, INC., San Francisco, CA (US)

(72) Inventors: David Ethan KENNERLY, San Francisco, CA (US); Benjamin Lee AHRONI, San Francisco, CA (US); Aaron KALUSZKA, Hayward, CA (US)

(21) Appl. No.: 14/573,384

(22) Filed: Dec. 17, 2014

Related U.S. Application Data
(60) Provisional application No. 61/919,785, filed on Dec. 22, 2013.

(51) Int. Cl. G09B 5/02; G09B 19/00

(52) U.S. Cl. CPC G09B 5/02; G09B 19/00

(57) ABSTRACT

A computing device configurable to assess cognitive ability of a user operating a client computer/device by administering a training session. The training session includes presenting a transporter at a starting location on a track, along with two or more unique items for pick-up and two or more corresponding locations for drop-off. The user selects a route to travel to pick-up all items available for pick-up and delivery within an allocated number of spaces.

### CROSS-REFERENCE

This application claims the benefit of U.S. Provisional Application No. 61/919,785, filed Dec. 22, 2013, entitled “Systems and Methods for a Physically Intuitive Resource-Constrained Route Planning Task for Enhanced Cognition” by Kennerly et al., which application is incorporated herein by reference.

### INTRODUCTION

Planning encompasses the process of formulating and evaluating thoughts and selecting and organizing actions necessary to achieve a goal. Planning involves the prediction of what the future will look like given input information and operates by integrating cognitive abilities such as working memory and attention. This executive function is a fundamental component of intelligent behavior, and enhancing this capacity is highly desirable. See, DAS, J. et al. “Cognitive planning: The psychological basis of intelligent behavior” Psyccritiques 42(7). Sage Publications, Inc. (1996).

Neuropsychological researchers commonly use puzzles such as the Tower of Hanoi and Tower of London to evaluate planning skills. See, SHALLICE, T., “Specific impairments of planning,” Philosophical Transactions of the Royal Society of London B, Biological Sciences 298(1089): 199-209 (1982). These tasks are effectively mathematical puzzles whereby subjects must formulate a constrained set of steps for moving objects from one location to another in the proper order. In solving the task, subjects may formulate a number of mathematical solutions, and well-defined solutions are required to complete more complex versions of the task. In the context of cognitive training, using such puzzles are not without their limitations. In particular, such problems are not directly related to the types of planning required in everyday activities. These stack-based logic problems have a general well-defined solution whereby they can be solved quickly and the task no longer scales in difficulty.

A more robust and ecologically valid task is desired. One such task involves deciding how to most efficiently travel from point to point picking up and dropping off objects which involves enumerating and imagining possibilities and outcomes. In computer science and operations research, this task embodies a vehicle routing problem. Vehicle routing problems are defined by choosing the shortest route for a number of vehicles to visit a number of points of interest. Researchers have studied and published results on the difficulty of many varieties of vehicle routing problems. See, PARRAGH, et al., “A survey on pick-up and delivery problems” J. für Betriebswirtschaft, 58(2):81-117 (2008). What is needed is a routing problem that utilizes limited capacity to carry travelers and limited fuel, which constrains travel distance to provide a more dynamic training exercise.

### SUMMARY OF THE INVENTION

Disclosed is a cognitive training exercise which is administered by a computing device that trains a user's ability to plan in an intuitive, engaging, and adaptively challenging way to enhance cognition. By enhancing cognition, the measurable cognition of a user is increased. The exercises delivered engage users in a task where the user is moves objects from one point to another. Objects are placed within a connected map. Users are limited in the distances objects can be moved within the map, or along one or more available tracks, and a number of objects that can move simultaneously, and thus must plan a route along the available tracks represented on the map ahead of time to successfully complete the task within an allocated resource. By choosing a destination from two or more possibilities and directing the objects to that choice, the user should select a route which is optimal based on the number of items to be moved, the distance to be moved, and the available distance to achieve movement of the items.

The disclosed vehicle routing problem involves a single vehicle with limited capacity to carry travelers and limited fuel, which constrains travel distance. There are both pick-ups and deliveries of passengers, which are located at points of interest on a map. By administering cognitive training exercises to a user which have limited capacity and distance constraints, the training exercises are better able to facilitate assessing cognitive ability. Additionally, by dynamically adjusting the complexity of future cognitive exercises, the system improves assessment and training of the cognitive ability of a user.

An aspect of the disclosure is directed to a method of enhancing a cognitive ability of a user. Suitable methods comprise: conducting, via a user interface display of a user computing device, a training session comprising, presenting, via the user interface display of the user computing device, a track, a transporter, a starting location for the transporter on the track, two or more transport items at a respective two or more pick-up locations on the track, a respective drop-off destination on the track for each of the two or more transport items; displaying to the user, via the user interface display of the user computing device, the transporter, the two or more transport items, and the respective drop-off destinations on the track; allowing the user, via the user interface display of the user computing device, to select one or more locations. The computing device assesses the locations selected by the user relative to one or more available routes. From the assessment, the computing device is configurable to determine a level of cognition. Such determination can be real-time. Based on one or more prior measurements of cognition, the computing device may then increase or decrease the level of difficulty of the presented transport items and drop-off locations. The increase or decrease of the level of difficulty can be performed real-time or substantially real-time such that the determination is transparent to the user. Each time, the user completes an exercise of moving transport items along a track to drop-off locations, the computing system is configurable to dynamically adjust the next exercise presented to take into consideration one or more prior performances by the user. Additionally, an available distance between the starting location, the respective pick-up locations and the respective drop-off destinations can be determined to comprise a plurality of potential paths. A plurality of potential paths can be, for example, three or more potential paths, and not all potential paths are a correct path. Additionally, the transporter is configurable to have an available capacity for transport items. For example, and without limitation, the transporter can be configured to carry three, four, five, or six items at a time. Additionally, the method of enhancing the cognitive ability of the user can include recording, via the user computing device, whether the user successfully directs the transporter from the starting location to each of the available pick-up locations and drop-off destinations, via the user interface display of the user computing device, within an allocated available resource. In at least some configurations, each of the respective unique pick-up location and the respective drop-off destinations is identifiable by a unique combination of two or more of shape, color, and size. Moreover, in at least some configurations, a complexity of the training session is determined by the user computing device from at least two or more of: a number of transport items, a number of drop-off destinations, an available distance movement for the transporter, and a speed of delivery of all of the transport items from the pick-up location to each of the drop-off destinations. Additionally, a complexity of the training session can be increased or decreased via the computing device according to a user performance during the training session.

Another aspect of the disclosure is directed to an apparatus for enhancing a cognitive ability of a user, comprising: a user computing device configured to conduct a training session, utilizing a user interface display of the user computing device, comprising, presenting, via the user interface display of the user computing device, a track, a transporter, a starting location for the transporter on the track, two or more transport items at a respective two or more pick-up locations on the track, a respective drop-off destination on the track for each of the two or more transport items; displaying to the user, via the user interface display of the user computing device, the transporter, the two or more transport items, and the respective drop-off destinations on the track; allowing the user, via the user interface display of the user computing device, to select one or more locations. The computing device assesses the locations selected by the user relative to one or more available routes. From the assessment, the computing device determines a level of cognition. Based on the level of cognition, the computing device may then increase or decrease the level of difficulty of the presented transport items and drop-off locations real-time. Each time, the user completes an exercise of moving transport items along a track to drop-off locations, the computing system dynamically adjusts the next exercise presented to take into consideration one or more prior performances by the user. Additionally, an available distance between the starting location, the respective pick-up locations and the respective drop-off destinations can be determined to comprise a plurality of potential paths. Additionally, the transporter is configurable to have an available capacity for transport items. For example, and without limitation, the transporter can be configured to carry three, four, five, or six items at a time. Additionally, the apparatus is configurable to enhance the cognitive ability of the user can include recording, via the user computing device, whether the user successfully directs the transporter from the starting location to each of the available pick-up locations and drop-off destinations, via the user interface display of the user computing device, within an allocated available resource. In at least some configurations, each of the respective unique pick-up location and the respective drop-off destinations is identifiable by a unique combination of two or more of shape, color, and size. Moreover, in at least some configurations, a complexity of the training session is determined by the user computing device from at least two or more of: a number of transport items, a number of drop-off destinations, an available distance movement for the transporter, and a speed of delivery of all of the transport items from the pick-up location to each of the drop-off destinations. Additionally, a complexity of the training session can be increased or decreased via the computing device according to a user performance during the training session.

Still another aspect of the disclosure is directed to a non-transitory computer readable storage medium tangibly storing computer program instructions capable of being executed by a computer processor, the computer program instructions defining a method comprising: determining, by the processor, a training session to assess cognitive ability of a user operating a client device, the cognitive ability assessment comprising a track, a transporter, a starting location for the transporter on the track, two or more transport items at a respective two or more pick-up locations on the track, a respective drop-off destination on the track for each of the two or more transport items; transmitting, by the processor to the client device, the route, the transporter at the starting location, two or more transport items at the respective pick-up locations, respective drop-off destinations, and an available energy; receiving, by the processor and from the user via the client device, two or more route stops; determining, by the processor, whether the received route delivers each of the available transport items for pick-up at their respective drop-off destinations; and transmitting, by the processor to the client device, an indication as to whether the route is correct. The computing device assesses the locations selected by the user relative to one or more available routes. From the assessment, the computing device determines a level of cognition. Based on the level of cognition, the computing device may then increase or decrease the level of difficulty of the presented transport items and drop-off locations. Each time, the user completes an exercise of moving transport items along a track to drop-off locations, the computing system dynamically adjusts the next exercise presented to take into consideration one or more prior performances by the user. Additionally, an available distance between the starting location, the respective pick-up locations and the respective drop-off destinations can be determined to comprise a plurality of potential paths. Additionally, the transporter is configurable to have an available capacity for transport items. For example, and without limitation, the transporter can be configured to carry three, four, five, or six items at a time. Additionally, the method of enhancing the cognitive ability of the user can include recording, via the user computing device, whether the user successfully directs the transporter from the starting location to each of the available pick-up locations and drop-off destinations, via the user interface display of the user computing device, within an allocated available resource. In at least some configurations, each of the respective unique pick-up location and the respective drop-off destinations is identifiable by a unique combination of two or more of shape, color, and size. Moreover, in at least some configurations, a complexity of the training session is determined by the user computing device from at least two or more of: a number of transport items, a number of drop-off destinations, an available distance movement for the transporter, and a speed of delivery of all of the transport items from the pick-up location to each of the drop-off destinations. Additionally, a complexity of the training session can be increased or decreased via the computing device according to a user performance during the training session.

Yet another aspect of the disclosure is directed to an apparatus for enhancing a cognitive ability of a user, comprising: a user computing device means including a means for conducting a training session, utilizing a user interface display means of the user computing device means, comprising, the user computing device means including a means for presenting on the user interface display means a track, a transporter, a starting location for the transporter on the track, two or more transport items at a respective two or more pick-up locations on the track, a respective drop-off destination on the track for each of the two or more transport items; the user interface display means further comprising a means for displaying to the user, via the user interface display of the user computing device, the transporter, the two or more transport items, and the respective drop-off destinations on the track; the user computing device means including a means for allowing the user, utilizing the user interface display means to select at least one or one or more locations. The computing device assesses the locations selected by the user relative to one or more available routes. From the assessment, the computing device means determines a level of cognition. Based on the level of cognition, the computing device means may then increase or decrease the level of difficulty of the presented transport items and drop-off locations. Each time, the user completes an exercise of moving transport items along a track to drop-off locations, the computing system dynamically adjusts the next exercise presented to take into consideration one or more prior performances by the user. Additionally, an available distance between the starting location, the respective pick-up locations and the respective drop-off destinations can be determined to comprise a plurality of potential paths. Additionally, the transporter is configurable to have an available capacity for transport items. For example, and without limitation, the transporter can be configured to carry three, four, five, or six items at a time. Additionally, the method of enhancing the cognitive ability of the user can include recording, via the user computing device, whether the user successfully directs the transporter from the starting location to each of the available pick-up locations and drop-off destinations, via the user interface display of the user computing device, within an allocated available resource. In at least some configurations, each of the respective unique pick-up location and the respective drop-off destinations is identifiable by a unique combination of two or more of shape, color, and size. Moreover, in at least some configurations, a complexity of the training session is determined by the user computing device from at least two or more of: a number of transport items, a number of drop-off destinations, an available distance movement for the transporter, and a speed of delivery of all of the transport items from the pick-up location to each of the drop-off destinations. Additionally, a complexity of the training session can be increased or decreased via the computing device according to a user performance during the training session.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the disclosure are set forth with particularity in the appended claims. A better understanding of the features and advantages of the present disclosure will be obtained by reference to the following detailed description that sets forth illustrative embodiments, in which the principles of the disclosure are utilized, and the accompanying drawings of which:

FIG. 1 is a screen shot illustrating a gaming round of a training exercise administered by the computing device that presents pairs of pick-up items and delivery locations;

FIG. 2 is a portion of a screen shot illustrating an available pick-up or delivery apparatus that is operated by a user wherein an indicator of available distance can also be represented which indicates a remaining fuel or distance to be travelled;

FIG. 3 is a portion of a screen shot illustrating an available pick-up or delivery apparatus that is selected by a user wherein an indicator can also be represented which indicates no fuel is remaining or no further distance can be travelled;

FIG. 4 is a portion of a screen shot illustrating a status bar which can be generated by the system and displayed on the screen during the training exercise where an inventory which designates passengers that have been picked-up, but not yet dropped-off or delivered;

FIG. 5 illustrates a game flow operation executable by a computing device;

FIG. 6 is a screen shot illustrating a game round of a training exercise administered by the computing device representing a lower difficulty level of a game which contains fewer pick-up locations and delivery locations and fewer potential paths for travel;

FIG. 7 is a screen shot illustrating a game round of a training exercise administered by the computing device representing a higher difficulty level of a game which contains a greater number of pairs of pick-ups locations and delivery locations and more potential paths for travel;

FIG. 8 illustrates a tutorial flow operation executable by a computing device;

FIGS. 9A-D are screen shots illustrating a tutorial for the training exercise which describes a method of performing the game during use through a series of prompts;

FIGS. 10A-B are screen shots providing interactive feedback for the training exercise, such as that presented during a tutorial session;

FIG. 11 is a screen shot providing information presented at the end of a tutorial session;

FIG. 12 is a heads-up display which is generated by the system and can be presented on the screen of a computing device to a user that indicates a current score for deliveries and time bonus in the trials to a specified time;

FIG. 13 is a screen shot which indicates a measure of progress for a user;

FIG. 14 a screen shot illustrating a final screen containing a user's score, number correct, and a next session level; and

FIG. 15 is a flow diagram executable by a computing device which directs players to play the tutorial and setting game difficulty.

### DETAILED DESCRIPTION OF THE INVENTION

An aspect of the disclosed exercises provides a game generated by a computing device and delivered on a computing device screen of a user's computing device wherein a user is instructed to plan the shortest route to pick-up and deliver items presented on the screen of the computing device utilizing a single transporter which has a limited capacity—either in number of items carried at a single time, potential distance travelled, or both. The exercises generated by the computer and delivered to the user's computing device requires that a user (player) find the shortest path between each pick-up and delivery, while considering heuristics, metaheuristics, and a plurality of possible routes. By administering cognitive training exercises to a user, assessing cognitive ability and then dynamically adjusting the complexity of future cognitive exercises, the system improves assessment and training of the cognitive ability of a user.

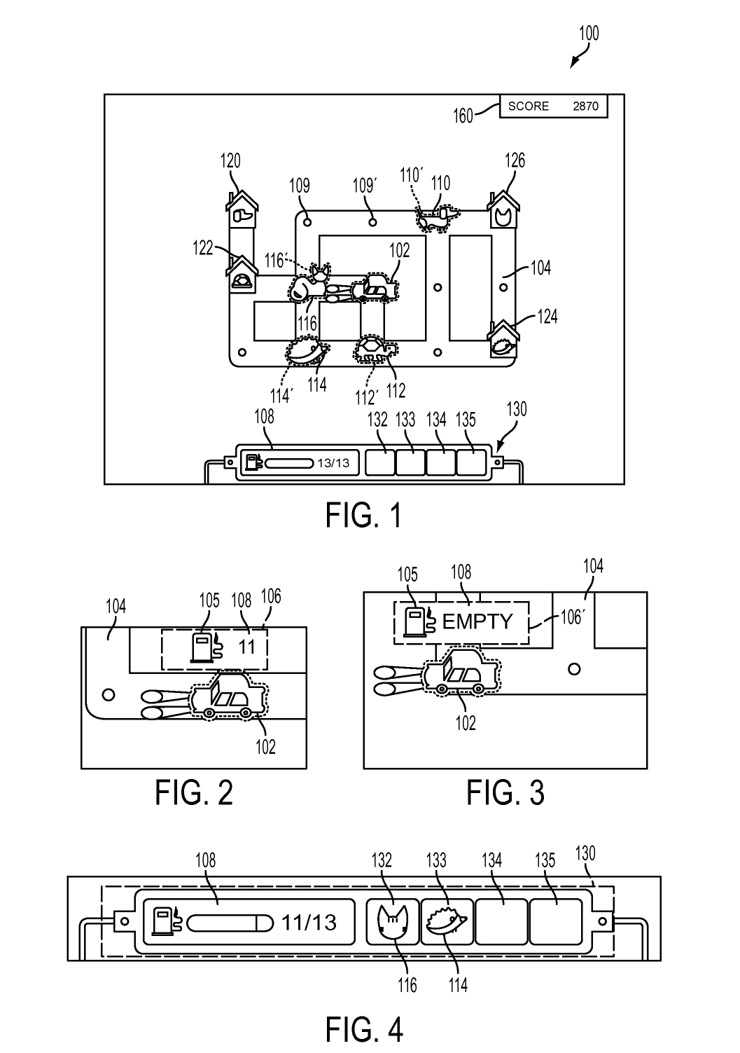

A core gameplay mechanism of the exercises generated by a computing device involves planning and executing the shortest route along a track 104 or path having a plurality of possible routes. The gameplay involves the user picking-up and delivering items, such as passengers, with a transporter 102 that can be configured to have one or more of a limited capacity and a limited travelable distance. In one example, disclosed herein, a point of interest is either one pick-up location or one delivery location along the track 104. Each track 104 can have multiple pick-up locations and multiple drop-off or delivery locations. As illustrated in FIG. 1, the computing device generates a screen display 100 that is presented to a user (or player) via the computing device. The display 100 illustrates, for example, an icon representing a transporter 102, such as a vehicle on a track 104, or path, having at least one point of interest that is selectable by the user engaging a user input device, such as by pointing and clicking a desired location a computer mouse, tapping on a touch screen, or engaging another suitable pointing device in 2D or 3D space.

As shown in FIG. 1, a plurality of items available for pick-up at pick-up locations 110, 112, 114, 116 are generated by the computing device and presented by the system on the screen display 100 which are represented by individual icons. Suitable icons can have one or more distinguishing characteristics, such as shape, color, and caricature. Additionally, icons available for pick-up (i.e., selectable by the user) can be further distinguished by, for example, a highlighted band 110′, 112′, 114′, 116′ around the exterior of the icon when the item at a pick-up location is available for pick-up. The icons used for the pick-up item and the delivery location are visually distinguishable from each other and from the icon used for the vehicle used to achieve the pick-up and drop-off (delivery). As shown in FIG. 1 the items to be picked-up have two distinguishing characteristics: a first characteristic is that of a caricature of, for example, an animal and a second characteristic is color. For example, a first pick-up location 110 is represented by a blue dog; a second pick-up location 112 is represented by a blue turtle; a third pick-up location 114 is represented by a purple hedgehog; and a fourth pick-up location 116 is represented by a pink cat. Each of the items at each of the pick-up locations correspond to a drop-off location or drop-off destination corresponding to that pick-up item or transport item. Corresponding delivery locations 120, 122, 124, 126 are represented by icons have at least one matching visual aspect to the pick-up icon. For example, a house which a partial image of a blue dog 120. The delivery locations 120, 122, 124, 126 are initially presented as just their shape as shown in FIG. 1. A heads-up score display 160 can be provided on screen which provides feedback to the user on the trial of game play, the time bonus, and the score.

The transporter 102 used to achieve the pick-up and drop-off as illustrated is an orange car. As will be appreciated by those skilled in the art, configurations can use one or more visual aspects to distinguish between the various components. Additionally, the transporter 102 used to achieve pick-up and drop-off can be a car, as illustrated, or any other suitable icon including, for example, train, bus, plane, box, etc.

In an implementation, as shown in FIG. 1, points of interest, or pick-up locations, are illustrated which are depicted on an orthogonal grid. As will be appreciated by those skilled in the art, in other implementations the layout is not limited to an orthogonal grid as shown in FIG. 1. Additionally, other physical representations of pick-up items and drop-off locations could be employed without departing from the scope of the disclosure. Such additional representations include, for example, human passengers expecting a taxi with a corresponding pick-up and drop-off location, parcels designated for delivery from a manufacturer to a retailer, and the like. Additionally, other representations of a transport device can be used without departing from the scope of the disclosure. Such other representations include, for example, a train, a boat, a ship, a cart, a horse, and so on.

After a point of interest is selected by the user, the transporter 102 travels along the path selected by the user. Ideally, the user will instruct, via the computing device, the transporter 102 to travel along the shortest available path to the point of interest. By selecting the shortest path, the transporter 102 will provide feedback to the user that corresponds to an amount of fuel consumed. Fuel is illustrated as a gas pump 105 and the amount of fuel remaining as a display 106, 106′. Other depictions of fuel can include, for example, a battery, a power station, etc. A remaining amount of fuel can be depicted as a number, as shown in display 106 in FIG. 2, or as remaining bars on a battery, etc., or as a word such as “empty” in display 106′ in FIG. 3. Distance markers 109, 109′ can be provided at intervals along the track 104 as shown in FIG. 1.

A distance between two markers, e.g. between a first marker 109, and a second marker 109′ can represent an amount of fuel used by the vehicle (or transporter) to travel a set distance. Thus, for example, the pink cat 116 is one marker from the purple hedgehog 114, while the delivery location 116 for the pink cat is two markers from the delivery location 124 for the purple hedgehog. In the configuration illustrated, each unit of fuel available corresponds to a unit along the length of the path (one unit of fuel per cell length A in the grid). Other implementations could include paths that require different amounts of fuel or areas where fuel is replenished during game play. As shown in FIG. 2 visual feedback 108 indicates the amount of fuel remaining. If the transporter 102 has exhausted its supply of fuel, then this can be indicated 106′ as shown in FIG. 3.

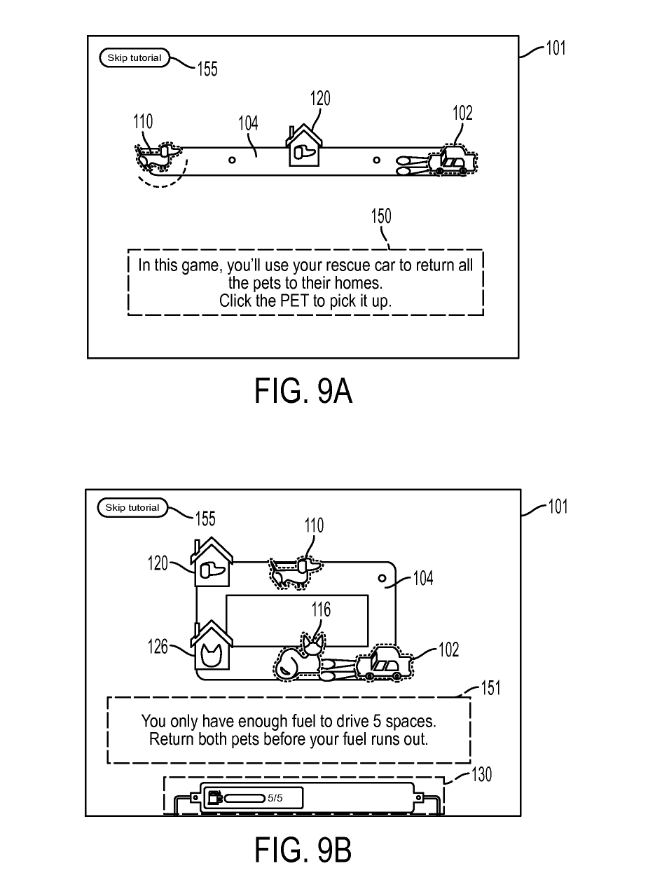

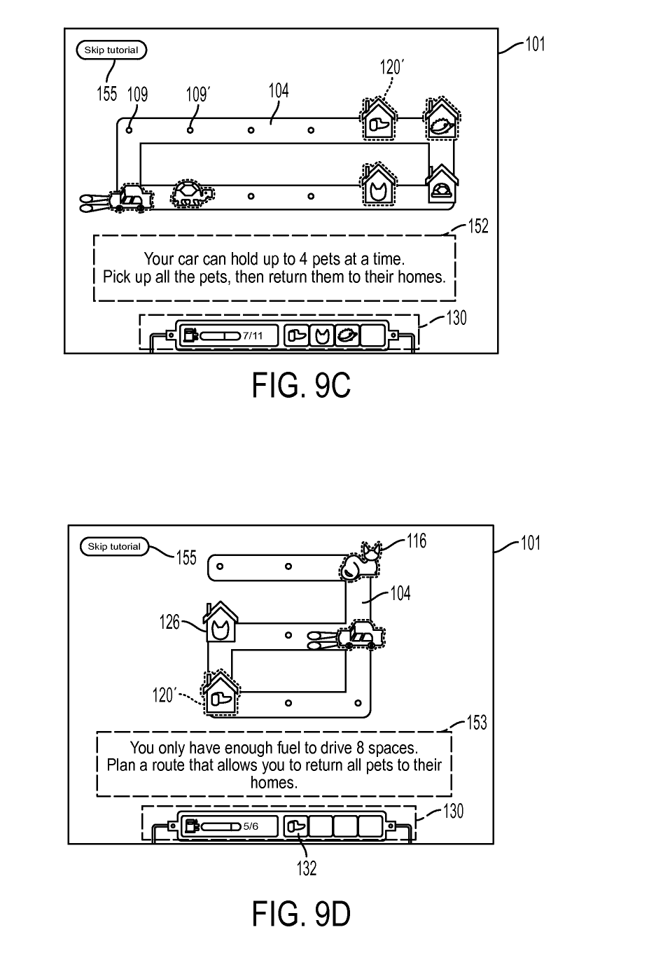

A status display 130 can be provided as shown at the bottom of FIG. 1 and in FIG. 4. If the user has achieved a pick-up using the user interface, then the passenger that has been picked-up is removed from the map on screen display 100 and placed into the vehicle inventory represented on the status display 130. For example, the inventory shown in FIG. 1 has four empty slots 132, 133, 134, 135 for passengers. Once the user arrives at a pick-up location and/or selects a passenger from a pick-up location, for example the pink cat 116, and then the purple hedgehog 114, those icons it would move from the grid as illustrated in FIG. 1 to a slot representing a passenger on the status display 130. The slots can be filled in the order the item that was picked-up, or any other order that is suitable. As shown in FIG. 4, the pink cat 116, which is nearer to the transporter 102 in FIG. 1 can be picked-up first and placed into a first slot 132, and the purple hedgehog 114 can be placed into a second slot 133. Once an item is picked-up, its corresponding drop-off location changes configuration to indicate that the drop-off location is available to receive a delivery. For example, as shown below in FIG. 9D, the blue dog 110 is in the slot 132 and the corresponding drop-off location 120 has been highlighted 120′ to indicate that the drop-off location is available to receive a delivery of the blue dog 110.

If the vehicle inventory indicator represented on the status display 130 is full (e.g., all of the slots are filled with icons representing items that have been picked-up), then the system is configurable so that a visual indicator displayed at each of the pick-up locations that the ability pick-up is disabled. This can occur, for example, by removing the highlight from around items available for pick-up once the inventory status 130 is full, or by any other suitable mechanism. If a delivery is available at a location, then after the transporter or vehicle arrives at a delivery point, a passenger is removed from the vehicle inventory. Additionally, the delivery point can be removed from the map entirely or can be visually changed (such as shadowed) to indicate delivery point and delivery completion.

During the game play and after completing any one of the presented exercises, the computing device is configurable to assess the one or more locations selected by the user relative to one or more available routes in an exercise. From the assessment, the computing device then determines a level of cognition of the user. Based on the level of cognition for the user, the computing device may then increase or decrease a level of difficulty of the presented transport items, drop-off locations and available routes. Each time, the user completes an exercise of moving transport items along a track to drop-off locations, the computing system is configurable to dynamically adjust the next exercise presented to the user to take into consideration one or more prior performances by the user. At the completion of each game or exercise, the computing system can determine a user cognition. Each calculated user cognition can then be stored and compared to earlier results and cognition scores. By administering cognitive training exercises to a user, assessing cognitive ability and then dynamically adjusting the complexity of future cognitive exercises based on one or more prior tests, the system improves assessment and training of the cognitive ability of a user.

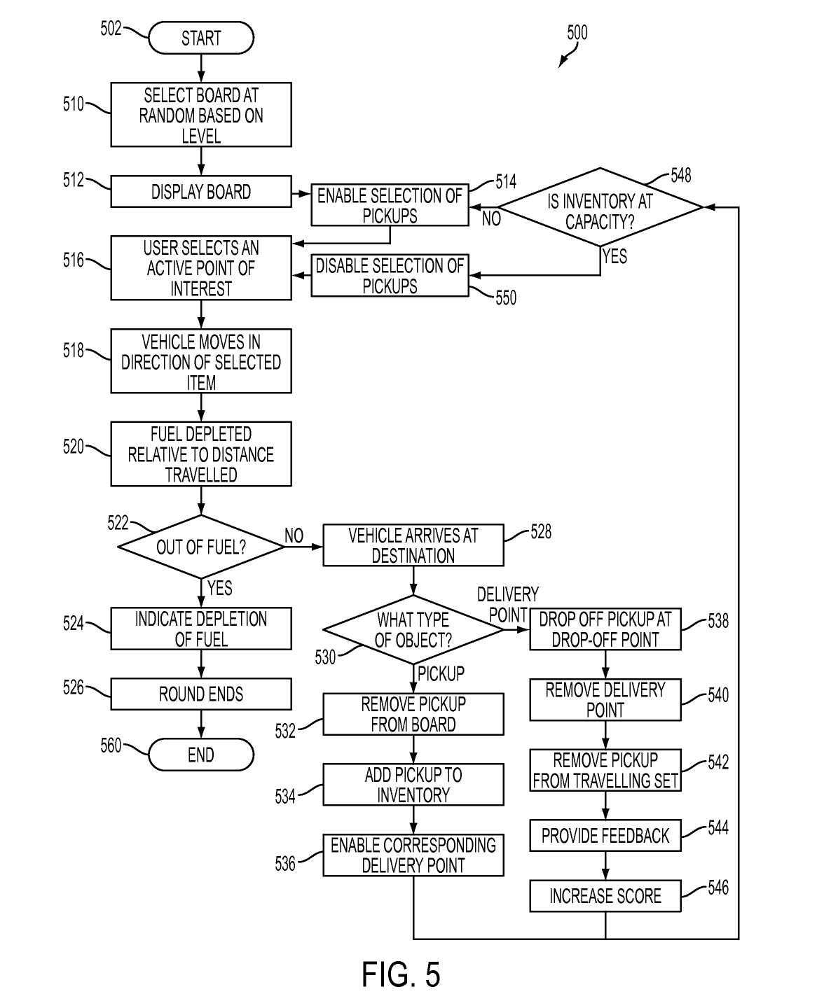

Turning now to FIG. 5, a diagram of game flow 500 is depicted which illustrates a game flow. After the game flow 500 starts 502, the computing device selects a board at random based on a skill level 510 of the user. The skill level can be selected by the user or can be selected by the computing device, either as a beginning level or based on prior performance in the game. Once the level is selected 510, the computing device displays a board 512 on the user interface. The displayed board 512 is configurable by the computing device so that it enables the selection of pick-ups 514 by the user, for example by adding a highlight around the exterior of items that can be picked-up. The user then selects an active point of interest 516, for example chooses a pick-up item. After selecting an active point of interest, the computing device causes the vehicle icon moves in a direction of a selected item 518. The computing device then determines a corresponding amount of fuel depletion and generates a display corresponding to a depletion of fuel 520 from the starting point to the selected active point of interest. During the movement of the vehicle to the selected item or upon arriving at the selected item, the computing device determines whether fuel is remaining with an “out of fuel?” 522 query. If the computing device determines that the travel selected by the user results in an out of fuel, then the computing device can generate an indication for display on the screen that the transporter of the game is out of fuel 524, followed by an indication that the game round has ended 526. If the computing device determines that it is not out of fuel, then the transporter arrives at its destination 528, at which point the computing device makes a determination as to the type of object that is located at the destination 530. If the destination is a pick-up location, then the computing device causes the item at the pick-up location to be removed from the board display 532 and added to the display of pick-up inventory 534. Pick-up of an item can then enable a corresponding delivery point to be active and available by the system 536. If the object is a delivery or drop-off location, then a corresponding item in the inventory is dropped off at the drop-off point 538. The computing device then causes the delivery point to be inactivated or removed from the visible game board 540 and the corresponding item is removed from the travelling set 542. Feedback can then be provided by the computing device to the user 544. Additionally, the computing device can calculate a score and an increase in score 546 may be presented by the display where the drop-off completes a pick-up and drop-off cycle. Once the corresponding delivery point is enabled 536 or the drop-off has been achieved with the corresponding increase in score 546, the computing device determines whether the inventory of the transporter is at capacity 548. If the computing device determines that the inventory is at capacity, then the ability of a user to select items for pick-up is disabled 550 by the computing device and the user selects an active point of interest 516. If the inventory is not at capacity, then the computing device enables the ability of the user to select an active point of interest 516 and proceeds through the game.

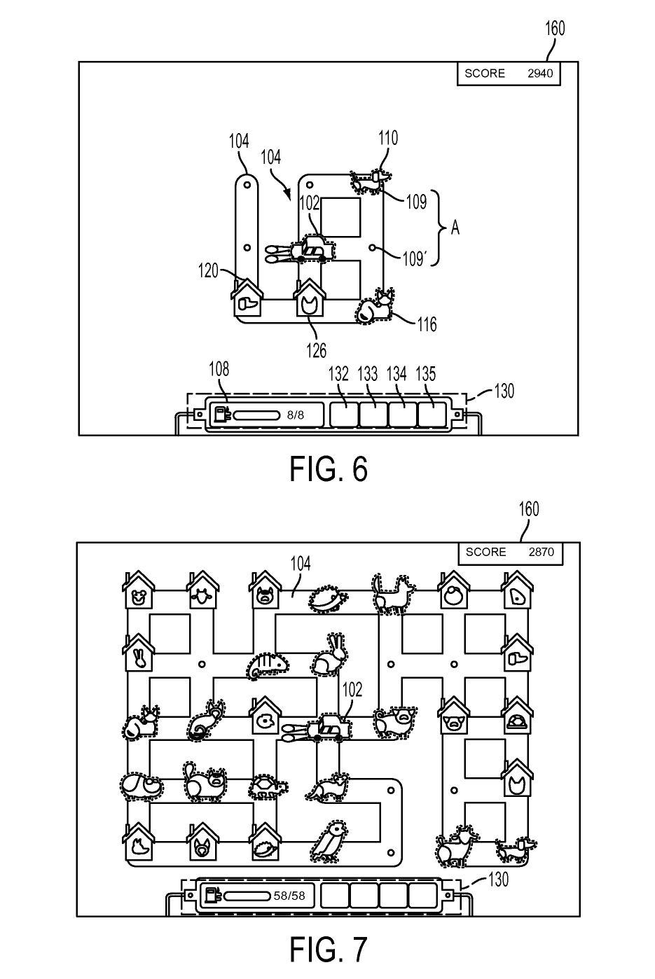

The computing device can moderate task difficulty by a set of parameters, which increases to adapt to a user's skill. For example, the screen display 100 presented by the computing device to a user having a low level of difficulty illustrates a track 104 with a short route on which the transporter 102 travels to move a first icon 110 to its delivery location 120, and a second item 116, to its corresponding delivery location 126, as shown in FIG. 6. Prior to the start of the game, the vehicle inventory represented on the inventory display 130 which includes a fuel gauge 108, shows no items picked-up and a full tank of fuel (8/8). A more difficult game generatable by the computing device is depicted in FIG. 7, where the screen 100 depicts the same four pick-up items and delivery locations as shown in FIG. 1 but illustrates a generated track 104 with a more complicated route from which the user can select a travel route for the transporter 102. A total of fourteen (14) items are displayed, wherein four (4) of the items are the same as items shown in FIG. 1, and an additional ten (10) unique items is presented along with a corresponding ten (10) unique drop-off locations. The amount of fuel available on the fuel gauge 108 in the vehicle inventory 130 reflects the amount of difficulty of the game. The parameters are the number of pairs of pick-ups and deliveries, the number of locations and distance between them, and the amount of fuel available. Task difficulty is primarily defined by the number of pairs of pick-ups and deliveries. The task difficulty can also increase as the distance between locations increases complexity moderately. Thus, in an exemplar implementation, difficulty levels alternate in increasing the number of pairs of pick-ups and deliveries, and the distance between locations. Furthermore, a time bonus can be added upon completing the task in order to encourage users to make quicker decisions. In other implementations dynamic actors could be added whereby pick-ups and delivery points could be added and removed outside of the user's control, changing the balance of prioritization.

A route can be a sequence of pick-ups and drop-offs or deliveries. Vehicle routing problems are generally understood to be non-polynomial-hard problems. This means that as the number of points of interest to visit increases, the time required to find the shortest route grows at a rate greater than a polynomial factor of the number of points of interest. The asymptote of a vehicle routing problem seems be factorial, which is a daunting degree of time complexity. A factorial is the multiplication a number by each counting number up to that number. For example, the factorial of 5 is 1 times 2 times 3 times 4 times 5, which equals 120. The factorial of 10 is 3,628,800. The factorial of just one more, from 10 to 11, is 39,916,800. To encourage users to train their planning skills by evaluating and optimizing the possible routes, we must determine the minimum amount of fuel required to solve a map configuration. At first, a generous surplus of fuel is allocated to build confidence in task without yet demanding mastery. On each subsequent round, the amount of fuel provided can be decreased towards a minimum value. A separate route searcher program searches for short routes and updates the data file for each map configuration. The route searcher may not have found the shortest route, so by observing a very large number of user sessions searches for short routes, another program harvests the minimum route lengths that those users found. This program updates the data of the shortest known routes with any shorter route. Each session can be a related set of communications between a user and the computing device.

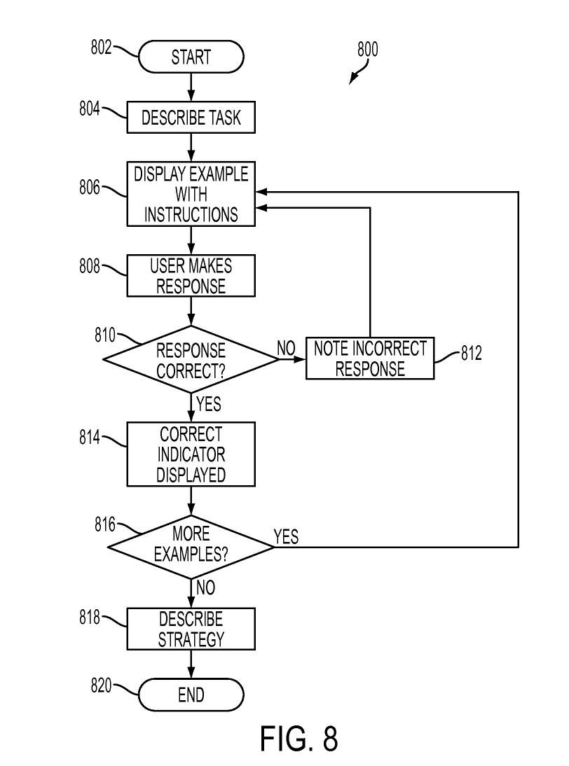

The user can also be introduced to the training exercise via a short interactive tutorial describing the gameplay elements. For example, as shown in the flow diagram 800 of FIG. 8, the tutorial starts 802. Once started, the tutorial describes a task 804 to be accomplished by the user when playing the game. Thereafter an example of the task is displayed 806 by the computing device. The system is configurable so that the computing device requests a response from the user 808. The computing device then determines of the response is correct 810. If the response is not correct 812, then the computing device instructs the system to display an example with instructions 806 and solicits the user's input again 808. If the response is correct, the computing device instructs the system to display an indicator that the response was correct 814 to the user. The system or the user then determines whether more examples are required 816. If more examples are desired, then another example is displayed with instructions 806, and the flow repeats. If no more examples are desired, then the system describes the strategy of the game 818, after which the tutorial ends 820.

An embodiment of the tutorial flow described in FIG. 8 is shown in FIGS. 9A-D. During the tutorial, a tutorial screen 101 is generated by the computing device and displayed to the user. In a first screen shown in FIG. 9A, for example, a description of the how to play the game is provided 150. Additionally, an example instruction can be provided. A suitable description, for example, would be “In this game, you'll use your rescue car to return all the pets to their homes. Click the PET to pick it up.” Additionally, a transporter 102 is illustrated positioned on a portion of a track 104. Additionally, a pick-up icon 110 and a corresponding drop-off icon 120 is illustrated. At the next screen, shown in FIG. 9B, additional description of the potential complexity of the game is provided. For example, a transporter 102 shown in a track 104 two potential drop-off locations shown 120, 126 and two items 110, 116 for pick-up on the track 104. On this screen, the vehicle inventory represented on the status display 130 is empty and the fuel indicator is full. Additional instruction 151 can be provided such as “You only have enough fuel to drive 5 spaces. Return both pets before your fuel runs out.”

At the next screen, shown in FIG. 9C, additional description of the potential complexity of the game is provided. For example, a transporter 102 shown in a track 104 four potential drop-off locations shown 120, 122, 124, 126 and four items 110, 112, 114, 116 for pick-up either on the track 104 or positioned within the vehicle inventory represented on the status display 130. Additional instruction 152 can be provided such as “Your car can hold up to 4 pets at a time. Pick-up all the pets, then return them to their homes.” At the next screen, shown in FIG. 9D, additional description of the potential complexity of the game is provided. For example, a transporter 102 shown in a track 104 two potential drop-off locations shown 120, 126 and two items 110, 116 for pick-up either on the track 104 or positioned within the vehicle inventory represented on the status display 130. Additional instruction 153 can be provided such as “You only have enough fuel to drive 8 spaces. Plan a route that allows you to return all pets to their homes.” At any time during any of the tutorial screens, the user can elect to skip the tutorial 155 by selecting the button on the screen to exit the tutorial.

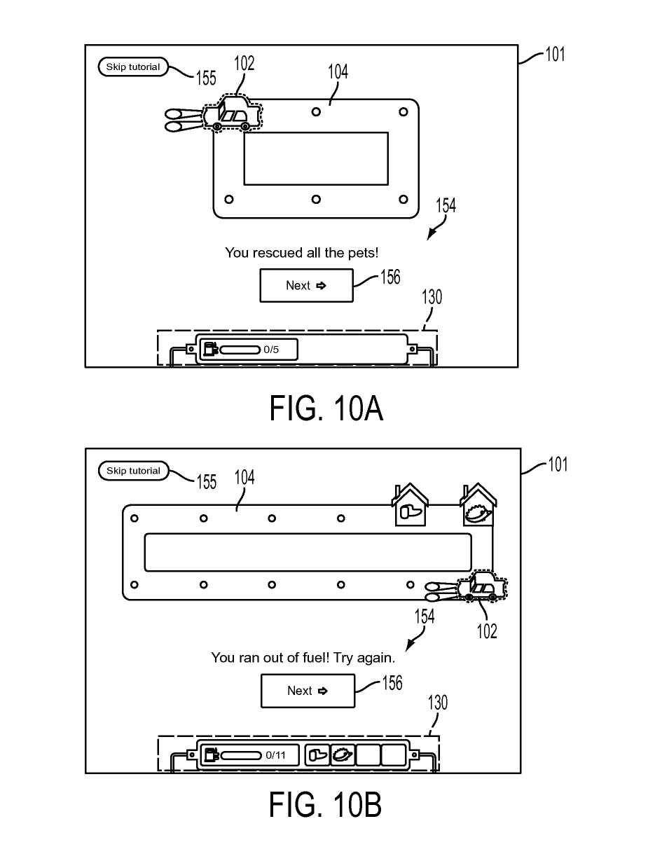

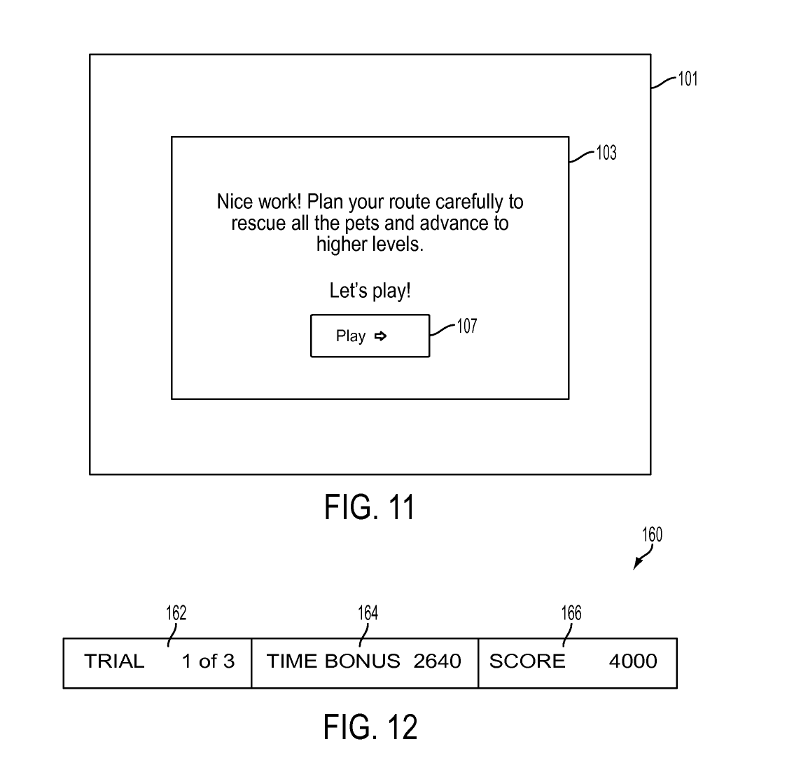

Additional tutorial features are shown in FIGS. 10A-B. These additional features illustrate important gameplay features such as vehicle, pick-up, delivery, and the method of input to select a pick-up or delivery are explained with animations. Interactive feedback informs users of their success in understanding the task, and players are given the chance to retry after exhausting the vehicle's supply of fuel. Additional instructions or feedback can be provided such as “You rescued all the pets” 154 or “You ran out of fuel! Try again.” At each closing screen, the user is given the option to proceed with a next button 156. After a number of successful trials, the player is invited to start the game with a message 103 such as “Nice work! Plan your route carefully to rescue all the pets and advance to higher levels,” and a play button 107, as shown in FIG. 11. The tutorial may be recalled in the future if a player needs to be reminded how to play and dismissed if not needed. The number of trials and cumulative score for deliveries in all trials so far is designated in a heads-up display 160 on the screen such as shown in FIG. 12. The heads-up display 160 can include an indication of trials 162, such as Trial 1 of 3, a time indicator 164 such as “time bonus ##”, and a score 166.

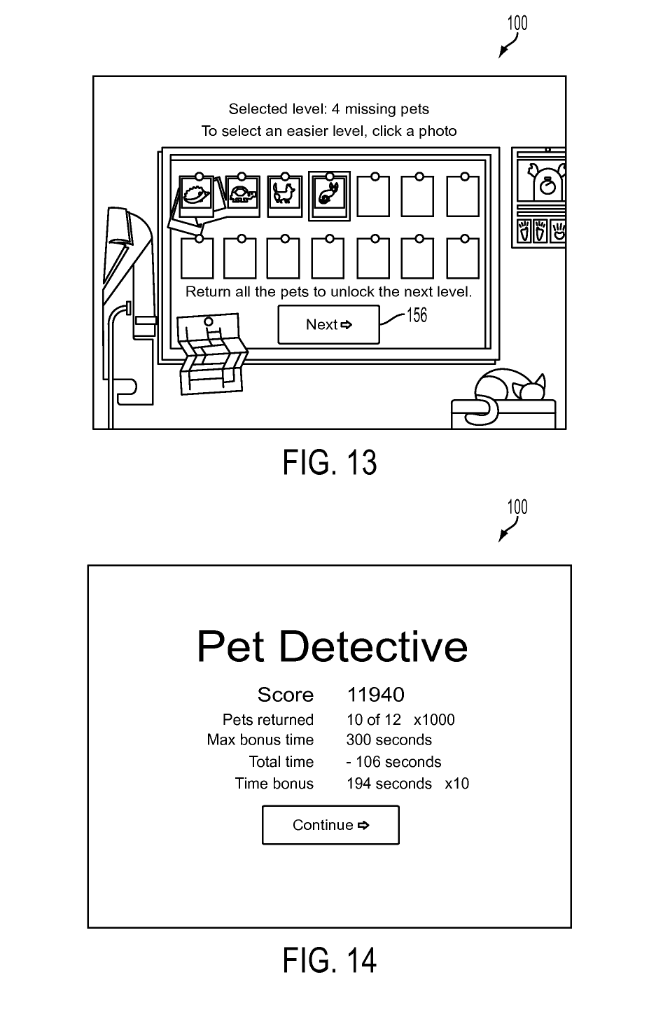

Before the main gameplay, the user is presented with high-level status of progress through levels of difficulty as shown in FIG. 13. The screen identifies the current level of difficulty attained, and provides the option of selecting a lower level of difficulty. A next button 156 is provided which, when activated by the user, takes the user to the next screen.

After finishing a number of trials, a review screen 100 displays the score for pick-ups and an optional time bonus if the user finished within a few minutes as shown in FIG. 14. If all deliveries in all rounds are completed, then the level of the next session increases.

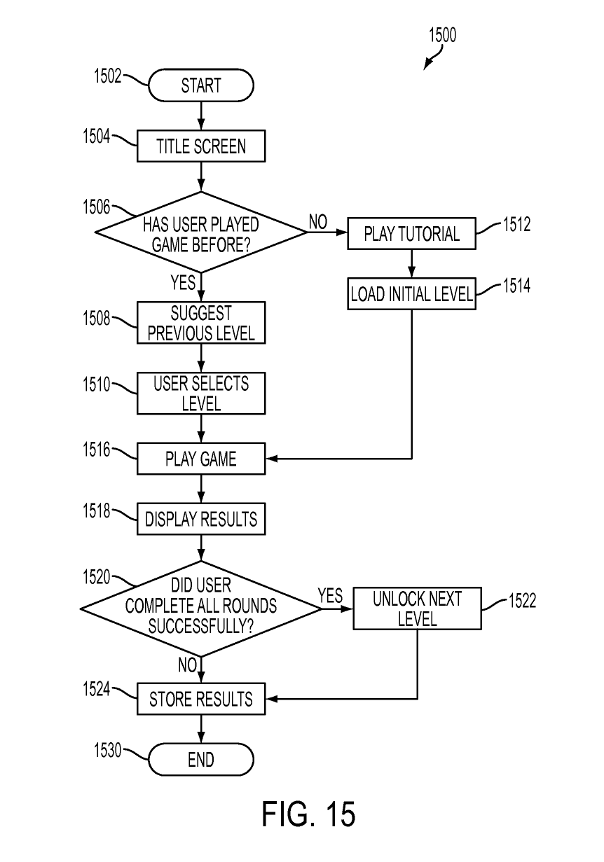

Before gameplay, the user may optionally select a lower level of difficulty in order to perfect that performance or to adjust to current performance conditions independent of best performance so far, such as the user's health and mood Instruction describes that to unlock a higher level of difficulty, all the pick-ups of the highest available level of difficulty must be returned to their corresponding deliveries with the allotted fuel, though other unlocking criteria are possible. If all pick-ups are dropped off, then a screen afterward and before the score review indicates the next level with a pair of a new pick-up and delivery is displayed. As described in FIG. 15 a tutorial flow 1500 is disclosed. The tutorial flow 1500 starts 1502 and presents a title screen 1504. The system then determines whether the user has played the game before 1506. If the game has not been played, a tutorial is played 1512. After the tutorial an initial load with an initial difficulty level is made 1514. If the game has been played, then the system suggests continuation of the previous level 1508. The user then selects a level 1510 (e.g., confirming that the level be continued or that a different level be attempted). Thereafter, the game begins 1516. After the game is played, the system displays results 1518 reflecting the user's performance in the game. Thereafter, the system determines if the user completed all rounds successfully 1520. If all rounds were completed successfully, then the next level of game play is unlocked 1522. Regardless of whether the rounds were completed successfully, the system stores the results 1524 after which the process stops 1530.

In a current implementation, a map that displays the pick-ups, deliveries, and vehicle is comprised of an orthogonal grid of points. Other layouts could be presented. At least as many rows and columns are chosen to populate every pair of pick-ups and deliveries plus the single vehicle. Sometimes the grid is designed to be larger than the minimum number of points needed. Each point is comprised of a potential point of interest, and a combination of connections to orthogonally adjacent points. Every point in the grid has at least one path to every other point, making every point accessible from every other point. This is accomplished by an algorithm that connects in two-phases: a labyrinth phase, and a redundancy phase. Starting from the top left, a random adjacent point is connected to the current end of the connected points. If a dead-end is reached before all points are connected, then a random point that has an unconnected neighbor is selected as the next end to repeat the random path expansion. This results in a very simple maze that might be a labyrinth, having no branches, or having a few branches. Yet this limits the number of paths between waypoints, which limits the difficulty of finding the shortest path. To increase the difficulty of finding the shortest path, pairs of adjacent points that are currently not directly connected by an edge are shuffled and selected until a given proportion of the unconnected adjacent neighboring point pairs are connected. The result is a highly varied network of points, with several redundancies of paths that challenge the user to find the shortest path with maps that resemble city blocks. To complete the map generation, the pick-ups and deliveries are randomly shuffled to the tiles except a start location, which is reserved for the vehicle. Other methods of map generation may be used to the same effect.

The systems and methods according to aspects of the disclosed subject matter may utilize a variety of computer and computing systems, communications devices, networks and/or digital/logic devices for operation. Each may, in turn, be configurable to utilize a suitable computing device which can be manufactured with, loaded with and/or fetch from some storage device, and then execute, instructions that cause the computing device to perform a method according to aspects of the disclosed subject matter.

A computing device can include without limitation a mobile user device such as a mobile phone, a smart phone and a cellular phone, a personal digital assistant (“PDA”), such as a BlackBerry®, iPhone®, a tablet, a laptop and the like. In at least some configurations, a user can execute a browser application over a network, such as the Internet, to view and interact with digital content, such as screen displays. A display includes, for example, an interface that allows a visual presentation of data from a computing device. Access could be over or partially over other forms of computing and/or communications networks. A user may access a web-browser, e.g., to provide access to applications and data and other content located on a web-site or a web-page of a web-site.

A suitable computing device may include a processor to perform logic and other computing operations, e.g., a stand-alone computer processing unit (“CPU”), or hard wired logic as in a microcontroller, or a combination of both, and may execute instructions according to its operating system and the instructions to perform the steps of the method, or elements of the process. The user's computing device may be part of a network of computing devices and the methods of the disclosed subject matter may be performed by different computing devices associated with the network, perhaps in different physical locations, cooperating or otherwise interacting to perform a disclosed method. For example, a user's portable computing device may run an app alone or in conjunction with a remote computing device, such as a server on the Internet. For purposes of the present application, the term “computing device” includes any and all of the above discussed logic circuitry, communications devices and digital processing capabilities or combinations of these.

Certain embodiments of the disclosed subject matter may be described for illustrative purposes as steps of a method which may be executed on a computing device executing software, and illustrated, by way of example only, as a block diagram of a process flow. Such may also be considered as a software flow chart. Such block diagrams and like operational illustrations of a method performed or the operation of a computing device and any combination of blocks in a block diagram, can illustrate, as examples, software program code/instructions that can be provided to the computing device or at least abbreviated statements of the functionalities and operations performed by the computing device in executing the instructions. Some possible alternate implementation may involve the function, functionalities and operations noted in the blocks of a block diagram occurring out of the order noted in the block diagram, including occurring simultaneously or nearly so, or in another order or not occurring at all. Aspects of the disclosed subject matter may be implemented in parallel or seriatim in hardware, firmware, software or any combination(s) of these, co-located or remotely located, at least in part, from each other, e.g., in arrays or networks of computing devices, over interconnected networks, including the Internet, and the like.

The instructions may be stored on a suitable “machine readable medium” within a computing device or in communication with or otherwise accessible to the computing device. As used in the present application a machine readable medium is a tangible storage device and the instructions are stored in a non-transitory way. At the same time, during operation, the instructions may at some times be transitory, e.g., in transit from a remote storage device to a computing device over a communication link. However, when the machine readable medium is tangible and non-transitory, the instructions will be stored, for at least some period of time, in a memory storage device, such as a random access memory (RAM), read only memory (ROM), a magnetic or optical disc storage device, or the like, arrays and/or combinations of which may form a local cache memory, e.g., residing on a processor integrated circuit, a local main memory, e.g., housed within an enclosure for a processor of a computing device, a local electronic or disc hard drive, a remote storage location connected to a local server or a remote server access over a network, or the like. When so stored, the software will constitute a “machine readable medium,” that is both tangible and stores the instructions in a non-transitory form. At a minimum, therefore, the machine readable medium storing instructions for execution on an associated computing device will be “tangible” and “non-transitory” at the time of execution of instructions by a processor of a computing device and when the instructions are being stored for subsequent access by a computing device.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A method of enhancing a cognitive ability of a user, comprising:
conducting, via a user interface display of a user computing device, a training session comprising,
presenting, via the user interface display of the user computing device, a track, a transporter, a starting location for the transporter on the track, two or more transport items at a respective two or more pick-up locations on the track, a respective drop-off destination on the track for each of the two or more transport items;
displaying to the user, via the user interface display of the user computing device, the transporter, the two or more transport items, and the respective drop-off destinations on the track; and
allowing the user, via the user interface display of the user computing device, to select one or more locations.

2. The method of claim 1 wherein an available distance between the starting location, the respective pick-up locations and the respective drop-off destinations comprises a plurality of paths.

3. The method of claim 2 wherein the transporter has an available capacity for transport items.

4. The method of claim 3 further comprising:
recording, via the user computing device, whether the user successfully directs the transporter from the starting location to each of the available pick-up locations and drop-off destinations, via the user interface display of the user computing device, within an allocated available resource.

5. The method of claim 3 wherein each of the respective unique pick-up location and the respective drop-off destinations is identifiable by a unique combination of two or more of shape, color, and size.

6. The method of claim 1 wherein a complexity of the training session is determined by the user computing device from at least two or more of: a number of transport items, a number of drop-off destinations, an available distance movement for the transporter, and a speed of delivery of all of the transport items from the pick-up location to each of the drop-off destinations.

7. The method of claim 6 further comprising:
increasing or decreasing, via the user computing device, a complexity of the training session according to a user performance during the training session.

8. An apparatus for enhancing a cognitive ability of a user, comprising:
a user computing device configured to conduct a training session, utilizing a user interface display of the user computing device, comprising,
presenting, via the user interface display of the user computing device, a track, a transporter, a starting location for the transporter on the track, two or more transport items at a respective two or more pick-up locations on the track, a respective drop-off destination on the track for each of the two or more transport items;
displaying to the user, via the user interface display of the user computing device, the transporter, the two or more transport items, and the respective drop-off destinations on the track; and
allowing the user, via the user interface display of the user computing device, to select one or more locations.

9. The apparatus claim 8 wherein a route comprises a plurality of potential paths between the two or more transport items and the two or more destinations for drop-off.

10. The apparatus of claim 8 wherein the transporter has a limited capacity for transport items available pick-up.

11. The apparatus of claim 8 further comprising:
recording, via the user computing device, whether the user successfully directs the transporter from the starting location to each of available pick-up locations and drop-off destinations controlled by the user, via the user interface display of the user computing device, within an allocated available resource.

12. The apparatus of claim 10 wherein each of the respective unique pick-up location and the respective unique drop-off destinations is identifiable by a unique combination of two or more of shape, color, and size.

13. The apparatus of claim 8 wherein a complexity of the training session is determined by the user computing device from at least two or more of: a number of unique pick-up locations, a number of unique drop-off destinations, a number of potential routes between pick-up locations and drop-off destinations, an amount of allocated distance provided for travel to complete the pick-up and drop-off of all transport items, and a speed of delivery of all of the transport items from the pick-up location to each of the drop-off destinations.

14. The apparatus of claim 13 further comprising:
increasing or decreasing, via the user computing device, the complexity of the training session according to user performance during the training session.

15. A non-transitory computer readable storage medium tangibly storing computer program instructions capable of being executed by a computer processor, the computer program instructions defining a method comprising:
determining, by the processor, a training session to assess cognitive ability of a user operating a client device, the cognitive ability assessment comprising a track, a transporter, a starting location for the transporter on the track, two or more transport items at a respective two or more pick-up locations on the track, a respective drop-off destination on the track for each of the two or more transport items;
transmitting, by the processor to the client device, the route, the transporter at the starting location, two or more transport items at the respective pick-up locations, respective drop-off destinations, and an available energy;
receiving, by the processor and from the user via the client device, two or more route stops;
determining, by the processor, whether the received route delivers each of the available transport items for pick-up at their respective drop-off destinations; and
transmitting, by the processor to the client device, an indication as to whether the route is correct.

16. An apparatus for enhancing a cognitive ability of a user, comprising:
a user computing device means including a means for conduct a training session, utilizing a user interface display means of the user computing device means, comprising,
the user computing device means including a means for presenting on the user interface display means a track, a transporter, a starting location for the transporter on the track, two or more transport items at a respective two or more pick-up locations on the track, a respective drop-off destination on the track for each of the two or more transport items;
the user interface display means further comprising a means for displaying to the user, via the user interface display of the user computing device, the transporter, the two or more transport items, and the respective drop-off destinations on the track; and
the user computing device means including a means for allowing the user, utilizing the user interface display means to select one or more locations.

17. The apparatus of claim 16 wherein the route comprises a plurality of potential paths between the two or more transport items and the two or more destinations for drop-off.

18. The apparatus of claim 16 wherein the transporter has a limited capacity for transport items that can be picked-up.

19. The apparatus of claim 18 further comprising:
recording, via the user computing device means, whether the user successfully directs the transporter from a starting location to each of the available pick-up locations and drop-off destinations controlled by the user, via the user interface display means of the user computing device means, within an allocated available resource.

20. The apparatus of claim 18 wherein each of the respective unique pick-up locations and the respective unique drop-off destinations is identifiable by a unique combination of two or more of shape, color, and size.

21. The apparatus of claim 16 wherein a complexity of the training session is determined by the user computing device means from at least two or more of: a number of unique pick-up locations, a number of unique drop-off destinations, a number of potential routes between pick-up locations and drop-off destinations, an amount of allocated distance provided for travel to complete the pick-up and drop-off of all transport items, and a speed of delivery of all of the transport items from the pick-up location to each of the drop-off destinations.

22. The apparatus of claim 21 further comprising:
increasing or decreasing, via the user computing device means, the complexity of the training session according to user performance during the training session.
